(19) United States
(12) Patent Application Publication
(10) Pub. No.: US 2001/0026432 A1
(43) Pub. Date: Oct. 4, 2001

(54) Protector device

(76) Inventor: Takashi Katoda, Kochi-shi (JP)

Correspondence Address: NIXON PEABODY, LLP, 8180 GREENSBORO DRIVE, SUITE 800, MCLEAN, VA, 22102, US

(21) Appl. No.: 09/818,494

(22) Filed: Mar. 28, 2001

(30) Foreign Application Priority Data
Mar. 30, 2000 (JP) 2000-093108

(51) Int. Cl. H02H 1/00

(52) U.S. Cl. 361/117

(57) ABSTRACT

The present invention relates to a protector device, that is a device which protects other electronic devices from high voltage or large current, that is surge.

The protector device (10) according to the present invention utilizes breakdown phenomena of resistive oxide films (12) on the metal bars (11). The metal bars (11) are surrounded by a mixture (14) of oxidizing agent and refractory agent. The protector device returns from conductive state to non-conductive state in a very shot time because the surface in a very shot time because the surface of the metal bar is oxidized automatically due to the constitution described above.

### BACKGROUND OF THE INVENTION

1. Field of the Invention

The present invention relates to a protector device which returns itself to its non-conductive state in a very short time after conversion to its conductive state by surge including thunder.

2. Related Background Art

A protector device including an arrester is very important device to protect various electronic devices from surge including thunder. The protector device is a general name of devices which are used in order to protect other electronic devices from excess voltage, that is surge. An arrester is used to protect other electronic devices from thunder, that is extremely high voltage and large current. The arrester is one of the protector devices. The term of “protector device” is used here to indicate devices which are used in order to protect other electronic devices from excess voltage. However excess voltage is not limited to extremely high voltage such as thunder but includes low voltage if it is excess to a specified voltage.

A glass-tube type arrester has been used. It contains special gas between two electrodes in a glass tube. It is non-conductive unless surge is induced. When surge or thunder is induced, discharge starts and the gas between the electrodes changes to conductive. Current flows through the arrester and, it is lead to the earth. Discharge does not stop immediately after surge is removed. The arrester cannot protect other electronic devices from continuous current or next attack by surge or thunder. There are serious problems which a glass-tube and other type protector devices have which have been used. One of it is that a protector device must change from its resistive state to a conductive state in a very short time such as 0.03 μsec. when it is attacked by surge. Another problem is that a protector device should return from its conductive state to its resistive state when surge is removed.

In order to solve these problems in the prior art an arrester was proposed (Japanese Patent 118361, 1995 “Molybdenum arrester” by Seita Ohmori). It used a plural of molybdenum bars whose surface was oxidized. The arrester will be called here as a “molybdenum arrester”.

The molybdenum arrester leads current to the earth in a very short time when surge or thunder is induced. That is, it changes from non-conductive state to conductive state very quickly by breakdown of the oxide formed on the molybdenum bar. Moreover, it returns from conductive state to non-conductive state when surge or thunder is removed because molybdenum is oxidized quickly if it is in oxidizing atmosphere. The molybdenum arrester is very useful and economically efficient because it repeats change of the state automatically.

It is possible to use metals other than molybdenum in a protector device which functions with the same principle as the molybdenum arrester. Tantalum, chromium and aluminum are included is such metals. The principle of the molybdenum arrester can be applied also to a device in which single bar is used.

The molybdenum arrester has a problem to be solved. That is, the molybdenum bars must be set in oxidizing atmosphere in order to return from conductive state to non-conductive state by re-oxidization of molybdenum. However oxidizing atmosphere is after dangerous. It is necessary, therefore, to make clear materials which oxidizes molybdenum and is not dangerous. In addition, it is necessary to protect the arrester from heat produced by surge and re-oxidization of molybdenum after it is broken by surge.

### SUMMARY OF THE INVENTION

The present invention is directed to a protector device which contains oxidizing material suitable for a molybdenum protector device or the devices which function according to the principle of the molybdenum protector device. The oxidizing material oxidizes the metal quickly and is not dangerous. The material includes oxidizing agent and/or refractory agent.

The ratio between the oxidizing agent and the refractory agent is from 100:1 to 1:100.

### BRIEF DESCRIPTION OF THE DRAWINGS

FIG. 1 is a schematic view of an example of a protector device according to an embodiment of the present invention.

### DETAILED DESCRIPTION OF THE PREFERRED EMBODIMENTS

Reference will now be made in greater detail to a preferred embodiment of the invention, an example of which is illustrated in the accompanying drawing.

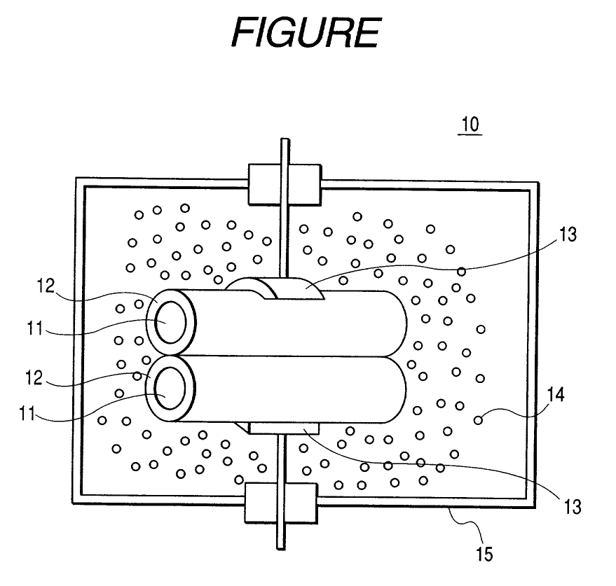

FIG. 1 shows an example of the protector device according to one embodiment of the present invention. In the example shown in FIG. 1, the protector device (10) includes two molybdenum bars (11) which have oxidized surface (12). The molybdenum bars (11) has a cylindrical shape and contact each other in a direction of length. The molybdenum bars (11) are fixed in a case (15). An electrode (13A) is formed on the upper-side of the upper molybdenum bar and another electrode (13B) is formed on the bottom of the lower molybdenum bar. The electrodes (13A, 13B) are formed directly on the molybdenum bar (11) or on the oxidized surface (12).

The case (15) is filled with powder or particle oxidizing agent or mixture (14) of oxidizing agent and refractory agent. The case (15) is sealed in order to prohibit introduction of air. It is desirable to seal the case (15) after exhausting following to setting of the molybdenum bars (11) and the mixture (14) of oxidizing and refractory agents.

In this embodiment, the oxidizing agent was potassium chlorate (KClO₃) and the refractory agent was silica (SiO₂). The ratio between potassium chlorate and silica was 1:3 (in weight) in this embodiment.

A relatively large fraction of the oxidizing agent in the mixture is desirable to oxide molybdenum after it is broken by surge and to return the device from conductive state to non-conductive as soon as possible.

However, a large fraction of the refractory agent is desirable to protect the device (10) from heat produced by serge or oxidizing reaction.

There is the optical ratio, therefore, between the oxidizing and the refractory agents depending on a particular application. Although a ratio from 100:1 to 1:100 is possible in general, a ratio 1:5 to 5:1 is desirable for many applications.

In the embodiment shown in FIG. 1, the molybdenum bars (11) were cylindrical with a diameter of 2 mm and a length of 7 mm. However, shape and size are not limited to those shown above. Although a thickness of the oxide film (12) was 20 μm in the embodiment shown in FIG. 1, it can be modified depending on a specified breakdown voltage.

Although molybdenum was used as the metal in the embodiment shown in FIG. 1, similar effect can be obtained with other metals such as tantalum, chromium and aluminum. Furthermore, oxidizing agent is not limited to potassium chlorate although it was used in the embodiment described above. For example, magnesium peroxide, calcium oxide and copper oxide can be used. In general, solid oxidizing agent is desirable from the viewpoints that it does not react with the surface of the case and air tightness is kept.

A breakdown voltage, that is a voltage at which a protector device changes from non-conductive state to conductive state, of the device according to the present invention can be changed widely depending on the specified application. The device can be used, therefore, to protect other electronic device from various surge including thunder. For example, in the device which has a breakdown voltage lower than 350 V for protection of small size device systems from surge, the refractory agent is not required because possibility to be broken by heat is small.

Electrical measurement was done for the device shown in FIG. 1. An impulse of 9 kV and 9 kA was applied to the device. Breakdown occurred at 700 V in 0.025 μs and continuous current was not observed. The device returned to resistive state again in a very short time of 0.03 μs. Almost the same results were obtained for 100 of the same devices as shown in FIG. 1.

What is claimed is:

1. A protector device which comprises single or multiple metal bars having a high resistive film and utilizes breakdown phenomena of the high resistive film,
CHARACTERIZED IN THAT
the metal bar or bars are surrounded with oxidizing agent.

2. A protector device which comprises single or multiple metal bars having a high resistive film and utilizes breakdown phenomena of the high resistive film
CHARACTERIZED IN THAT
the metal bar or bars are surrounded with oxidizing agent and refractory agent.

3. The protector device according to claim 2, wherein the ratio in weighting between the oxidizing agent and the refractory agent is 1:100 to 100:1.

4. The protector device according to claim 1, 2 or 3, wherein principal components of metal materials made of the metal bar is either one of molybdenum, tantalum chromium and aluminum.

5. The protector device according to claim 1, 2, 3 or 4, wherein the oxidizing agent is potassium chlorate.

6. The protector device according to claim 2, 3 or 4 wherein the refractory agent is silica.
